(19) United States
(12) Patent Application Publication
(10) Pub. No.: US 2017/0183809 A1
(43) Pub. Date: Jun. 29, 2017

(54) Article Loss Prevention Device

(71) Applicant: Stephen Kazimir, Ringwood, NJ (US)

(72) Inventor: Stephen Kazimir, Ringwood, NJ (US)

(21) Appl. No.: 15/394,730

(22) Filed: Dec. 29, 2016

Related U.S. Application Data
(60) Provisional application No. 62/272,534, filed on Dec. 29, 2015.

(51) Int. Cl. D06F 39/12; F16B 1/00

(52) U.S. Cl. CPC D06F 39/12; F16B 1/00; F16B 2001/0035; F16B 2001/0028

(57) ABSTRACT

An article loss prevention device for preventing loose articles of laundry placed on an appliance from falling behind, beside, or between is provided. The device comprises a center panel, a first side panel, and a second side panel with the first side panel and the second side panel connected to the center panel. The front sides of the center panel, the first side panel, and the second side panel face toward each other. A center securement mechanism is secured to the center panel, a first side panel mechanism is secured to the first side panel, and a second side panel securement mechanism is secured to the second side panel, The securement mechanisms are capable of interacting with the appliance to releasably secure the panels to the of the appliance. Articles of laundry placed on top of the appliance are inhibited from falling behind or beside the appliance or between adjacent appliances.

### CLAIM OF PRIORITY

This patent application claims priority under 35 USC 119 (e) (1) from U.S. Provisional Patent Application Ser. No. 62/272,534 filed Dec. 29, 2015, of common inventorship herewith entitled, “Washer Wall,” which is incorporated herein by reference as though the same were set forth in its entirety.

### FIELD OF THE INVENTION

The present invention pertains to the field of utility appliances, and more specifically to the field of catch all accessories for appliances.

### BACKGROUND OF THE INVENTION

Whether one owns a house in the suburbs or rents a studio apartment in the city, a residential dweller has a household to maintain. Floors are swept, carpets and rugs vacuumed and windows washed. Bedroom linens, bathroom towels and clothes are washed, dried, folded and put away. Kitchen floors are swept, mopped and waxed. Dishes are washed and dried, and sinks are scoured. Trashcans are emptied, dryer lint screens are cleaned and beds are made.

Aforementioned chores are performed on daily and weekly bases to keep one's living space clean and maintained in good order. One aspect of regular maintenance posing a particular problem is that washers and require space between themselves and the wall behind them for plumbing hookups and a dryer's exhaust hose. The space behind these appliances is a virtual magnet for loose articles of laundry from socks and underwear to washcloths and kids' clothes. As a consequence, one spends time and effort retrieving errant articles only to have to wash them again.

The prior art has put forth several designs for catch all accessories for furniture and appliances.

US Patent Publication 2012/0304896 to Keith Webb, Sr. and Angela Webb describes a furniture top backstop device that is used on a raised horizontal surface of a piece of furniture that includes a vertical wall backing that is in contact with a wall. A horizontal overlap surface is fitted between the furniture and the wall that is perpendicularly attached to the vertical wall backing. A plurality of bolts are inserted into the furniture to balance and support the horizontal overlap surface. A plurality of hooks or rings are inserted into the wall to hold and support the vertical wall backing and one or more slits to allow any electrical cords or wires to run through the furniture top backstop device.

U.S. Pat. No. 7,140,206 to Howard describes a device that prevents the loss of articles otherwise susceptible to falling behind furniture, appliances, fixtures or equipment or other large objects placed next to a wall which are not easy to move or reach under such as couches, wardrobes, desks, washers, dryers, refrigerators, filing cabinets and dressers. The compressible and flexible device is fitted from above into a crevice between the furniture and the wall. The device is held in place by friction created by the pressure caused by the deformation of the device between the furniture and wall. When flexed or compressed, the device creates a U shaped channel which catches items such as jewelry, makeup, currency, papers, office supplies or articles of clothing which otherwise fall behind the furniture. Using pressure and friction to maintain its placement, the article requires no fastening means to the wall or furniture. Objects caught in the device are removed easily by a user.

U.S. Pat. No. 7,140,206 to John T. Braun and Thomas M. Asher describes a gap cover device for covering a gap between clothes washer and dryer appliances having generally parallel juxtaposed sidewalls defining a gap between the appliances. The gap cover device includes a flexible elongated member having a generally T shaped transverse cross sectional configuration defining a gap spanning portion of sufficient transverse width to span the gap between the appliances, and an insert arm portion disposed generally normal to an underside of the gap spanning portion and adapted to be inserted into the gap. The insert arm portion has outwardly facing side surfaces at least one of which has a magnetic strip carried thereon operative to releasably secure the gap cover device to a selected one of the appliances to prevent objects from falling into the gap.

U.S. Pat. No. 5,518,309 to Jacinthe St-Pierre describes a device that catches pieces of clothes that fall behind a domestic appliance. The domestic appliance comprises an upper back guard and a rear face spaced apart from a wall standing behind the appliance. A basket clothes catching member is mounted behind the back guard substantially over the spacing between the rear face of the domestic appliance and the wall behind this appliance, whereby pieces of clothes susceptible to fall behind the appliance are caught by the basket member. The latter member is mounted on the back guard so that it can be pivoted to help to recover the caught pieces of clothes.

None of these prior art references describe the present invention.

### SUMMARY OF THE INVENTION

It is an object of the present invention to provide a magnetically mounted accessory or retaining wall for front loading washers and dryers that prevents loose articles of laundry placed on top of these machines from falling behind, beside or between these appliances.

The present invention is an article loss prevention device for preventing loose articles of laundry placed on an appliance from falling behind, beside, or between and converting the appliance into a convenient and secure area for sorting and folding. The article loss prevention device comprises a center panel, a first side panel connected to the center panel, and a second side panel connected to the center panel with the front sides of the center panel, the first side panel, and the second side panel facing toward each other. A center securement mechanism is secured to a rear side of the center panel, a first side panel mechanism is secured to the first side panel, and a second side panel securement mechanism is secured to the second side panel. The securement mechanisms are capable of interacting with the appliance thereby releasably securing the panels to the appliance. Articles of laundry placed on top of the appliance are inhibited from falling behind or beside the appliance or between adjacent appliances.

In addition, the present invention includes a method for preventing loose articles of laundry placed on an appliance from falling behind, beside, or between and converting the appliance into a convenient and secure area for sorting and folding. The method comprises providing a center panel, a first side panel, and a second side panel, connecting the first side panel to the center panel, connecting the second side panel to the center panel, facing front sides of the center panel, the first side panel, and the second side panel toward each other, securing the panels to the appliance, and inhibiting articles of laundry placed on top of the appliance from falling behind, beside, or between the appliance.

The present invention further includes an article loss prevention device for preventing loose articles of laundry placed on an appliance from falling behind, beside, or between and converting the appliance into a convenient and secure area for sorting and folding. The article loss prevention device comprises a center panel, a first side panel connected to the center panel, and a second side panel connected to the center panel with front sides of the center panel, the first side panel, and the second side panel facing each other. A flange is mounted to the rear side of the center panel and an adjustment plate is slidably positioned between the flange and the center panel. At least one center panel magnet mounted to the adjustment plate. At least one first side panel magnet secured to the first side panel and at least one second side panel magnet secured to the second side panel. The magnets are capable of interacting with the appliance thereby releasably securing the center panel to the appliance such that articles of laundry placed on top of the appliance are inhibited from falling behind or beside the appliance or between adjacent appliances.

### BRIEF DESCRIPTION OF THE DRAWINGS

FIG. 1 is a front perspective view illustrating an article loss prevention device, constructed in accordance with the present invention, with the article loss prevention device being installed on an appliance, i.e., a front loading washing machine.

FIG. 2 is a rear perspective view illustrating the article loss prevention device, constructed in accordance with the present invention, showing a hook and loop fastening strip that permits height adjustment of a center securement mechanism when the article loss prevention device is installed on the appliance.

FIG. 3 is a front perspective view illustrating the article loss prevention device, constructed in accordance with the present invention, showing a series of side panel securement mechanisms simple and secure attachment of the article loss prevention device to the appliance.

FIG. 4 is a perspective view illustrating the center securement mechanism of the article loss prevention device, constructed in accordance with the present invention, showing a functionality for height adjustment and an integral magnet for attachment to the rear side of the appliance.

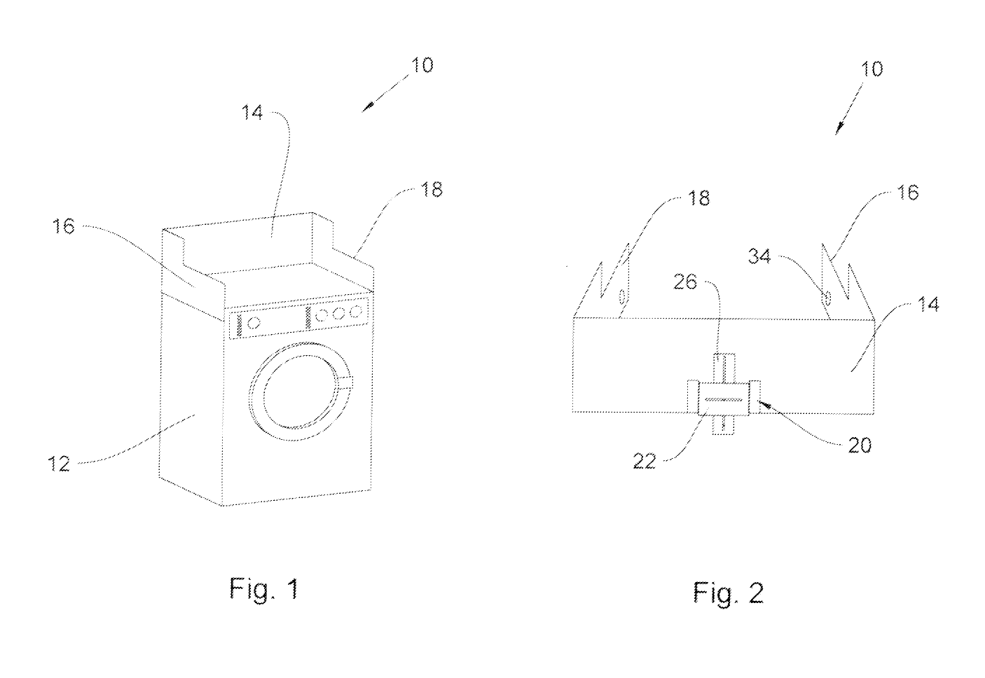

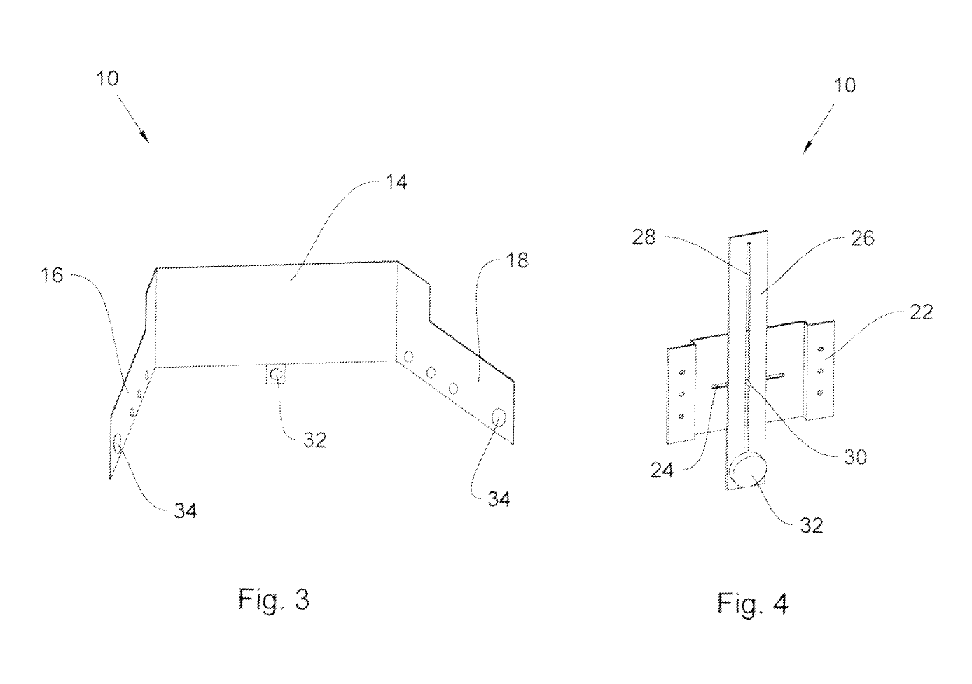

### DETAILED DESCRIPTION OF THE INVENTION

The present invention, hereafter referred to as an Article Loss Prevention Device 10, is a retaining wall for an appliance 12, especially front loading washers and dryers. The Article Loss Prevention Device 10 is configured to magnetically mount to the back and sides of the appliance 12. The Article Loss Prevention Device 10 effectively functions to prevent loose articles of laundry placed on top of the appliance 12 from falling behind, beside or between the appliances 12 and converts the top of the appliance 12 into a convenient and secure area for sorting and folding.

The Article Loss Prevention Device 10 of the present invention includes a center panel 14 having a front side, a rear side, a first end, and a second end, a first side panel 16 having a front side, a rear side, a first end, and a second end, and a second side panel 18 having a front side, a rear side, a first end, and a second end. The first end of the center panel 14 is connected to the first end of the first side panel 16 and the second end of the center panel 14 is connected to the first end of the second side panel 18 with the front sides of the center panel 14, the first side panel 16, and the second side panel 18 facing each other. In a preferred embodiment, the first side panel 16 and the second side panel 18 are joined to the center panel by creased folds or hinged seams. In addition, preferably, the center panel 14 is substantially perpendicular to the first side panel 16 and the second side panel 18 and the first side panel 16 is substantially parallel to the second side panel 18.

The center panel 14 of the Article Loss Prevention Device 10 of the present invention has a height preferably measuring approximately twenty-six (26″) inches in height. The first side panel 16 and the second side panel 18 step down in height from the first ends of the first side panel 16 and the second side panel 18 adjacent the center panel 14 and the second ends of the first side panel 16 and the second side panel 18. The height of the first side panel 16 and the second side panel 18 adjacent the first ends is equal to the height of the center panel 14. Preferably, the first side panel 16 and the second side panel 18 extends outward from the center panel 14 at the same height for a length of approximately thirteen (13″) inches before stepping down to a height of approximately six and one-half (6½″) inches to approximately seven (7″) inches. The first and second side panels 16, 18 extend at the lower height within a few inches from the front of the appliance 12, forming a lower fence extending forward from the higher side and center panel 14. The step down of the first side panel 16 and the second side panel 18 allow the user to more easily transfer articles over the lower portion of the first side panel 16 and the second side panel 18 while still maintaining a barrier to articles falling off the side of the appliance 12.

The Article Loss Prevention Device 10 of the present invention is preferably constructed from a molded plastic polymer such as vinyl. When laid flat and fully opened, a top edge of the Article Loss Prevention Device 10 preferably measures approximately fifty-two (52″) inches in length. A lower edge of the Article Loss Prevention Device 10 preferably measures approximately seventy-two (72″) inches in length. To accommodate washers and dryers of varying widths, the connecting or folding hinges of the Article Loss Prevention Device 10 are preferably fabricated in an elastic material. The elastic fold permits approximately one-half (½″) inch to one (1″) inch of retractable and extendable flexibility so the fold is fitted neatly into the rear corners of the appliance 12.

In addition, the Article Loss Prevention Device 10 of the present invention includes a center securement mechanism 20 secured to the rear side of the center panel 14. Preferably, the center securement mechanism 20 includes a flange 22 having a horizontal slot 24 formed in the approximate center of the flange 22. The flange 22 is mounted to the rear side of the center panel 14 approximately centered between the first end and the second end of the center panel 14. An adjustment plate 26 having a first end and a second end is slidably positioned between the flange 22 and the center panel 14. The adjustment plate 26 has a vertical slot 28 overlapping the horizontal slot 24 of the flange 22. A securing pin 30 or the like extends through the horizontal slot 24 and the vertical slot 28 allowing the user to fine tune horizontal and vertical movement of the adjustment plate 26 and releasably secure the adjustment plate 26 relative to the flange 22. A center panel magnet 32 is mounted to the second end of the adjustment plate 26 for releasable contact with the appliance 12 thereby releasably maintaining and anchoring the Article Loss Prevention Device 10 in a desired location relative to the appliance 12.

In another embodiment of the Article Loss Prevention Device 10 of the present invention, instead of the overlapping vertical slot 28 and horizontal slot 26 together with the securing pin 30, the adjustment plate 26 is releasably maintained by a hook and loop fastening system interacting between the adjustment plate 26 and the flange 22. Furthermore, in an embodiment of the Article Loss Prevention Device 10, the adjustment plate 26 can include a two or more center panel magnets 32 depending on the desires of the manufacturer and/or user.

Furthermore, the Article Loss Prevention Device 10 of the present invention includes a plurality of side panel magnets 34 secured to the first side panel 16 and the second side panel 18 for fastening the Article Loss Prevention Device 10 to the sides and the back of the washer or dryer. The side panel magnets 34 are preferably evenly spaced along a lower edge of the first side panel 16 and the second side panel 18. The side panel magnets 34 and/or the center panel magnets 32 can be uniform in size with each other or some of the side panel magnets 34 and/or the center panel magnets 32 can be a variety of sizes.

The Article Loss Prevention Device 10 of the present invention is preferably produced in a variety of colors to match color schemes of washers and dryers, and is accessorized with options such as carry handles and a shelf or cargo net to help with sorting. Engineered for easy and non-marring installation and removal, the Article Loss Prevention Device 10 is easily compacted for storage. Using the Article Loss Prevention Device 10 eliminates a common and vexing issue of a tendency of laundry to wind up behind or beside the appliance 12 or between adjacent appliances 12, i.e., the washer and dryer. The Article Loss Prevention Device 10 converts the top of the appliance 12 into a convenient and secure area for sorting and folding laundry. Durably constructed of a high quality materials, the Article Loss Prevention Device 10 will withstand many years of continued use.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. An article loss prevention device for preventing loose articles of laundry placed on an appliance from falling behind, beside, or between and converting the appliance into a convenient and secure area for sorting and folding, the appliance having a rear side, a first side, and a second side, the article loss prevention device comprising:
a center panel having a front side, a rear side, a first end, and a second end;
a first side panel having a front side, a rear side, a first end, and a second end, the first end of the first side panel being connected to the first end of the center panel;
a second side panel having a front side, a rear side, a first end, and a second end, the second end of the second side panel being connected to the first end of the center panel with the front sides of the center panel, the first side panel, and the second side panel facing toward each other;
a center securement mechanism secured to the rear side of the center panel;
a first side securement mechanism secured to the first side panel; and
a second side panel securement mechanism secured to the second side panel;
wherein the center securement mechanism is capable of interacting with the rear side of the appliance thereby releasably securing the center panel to the first side of the appliance;
wherein the first side panel securement mechanism is capable of interacting with the first side of the appliance thereby releasably securing the first side panel to the second side of the appliance;
wherein the second side panel securement mechanism is capable of interacting with the second side of the appliance thereby releasably securing the second side panel to the rear side of the appliance; and
wherein articles of laundry placed on top of the appliance are inhibited from falling behind or beside the appliance or between adjacent appliances.

2. The article loss prevention device of claim 1 wherein the first side panel and the second side panel step down in height from the first ends of the first side panel and the second side panel adjacent the center panel and the second ends of the first side panel and the second side panel, a first height of the first side panel and the second side panel adjacent the first ends is equal to a center panel height of the center panel, a second height of the first side panel and the second side panel adjacent the second ends is less than the center panel height of the center panel.

3. The article loss prevention device of claim 1 wherein the first side panel and the second side panel are joined to the center panel by creased folds or hinged seams.

4. The article loss prevention device of claim 3 wherein the center panel, the first side panel, and the second side panel are constructed from a molded plastic polymer.

5. The article loss prevention device of claim 3 wherein the connecting or folding hinges are fabricated in an elastic material.

6. The article loss prevention device of claim 1 wherein the center securement mechanism comprises:
a flange having a horizontal slot, the flange mounted to the rear side of the center panel;
an adjustment plate having a first end and a second end, the adjustment plate slidably positioned between the flange and the center panel, the adjustment plate having a vertical slot overlapping the horizontal slot of the flange; and
a securing pin extending through the horizontal slot for releasably securing the adjustment plate relative to the flange;
at least one center panel magnet mounted to the second end of the adjustment plate capable of releasable contact with rear side of the appliance.

7. The article loss prevention device of claim 6 wherein the flange is centered between the first end and the second end of the center panel.

8. The article loss prevention device of claim 1 wherein the center securement mechanism comprises:
a flange mounted to the rear side of the center panel;
an adjustment plate having a first end and a second end, the adjustment plate slidably positioned between the flange and the center panel;
a hook and loop fastening system interacting between the adjustment plate and the flange for releasably securing the adjustment plate relative to the flange; and
at least one center panel magnet mounted to the second end of the adjustment plate capable of releasable contact with rear side of the appliance.

9. The article loss prevention device of claim 1 wherein the center securement mechanism is at least one center panel magnets mounted to the center panel.

10. The article loss prevention device of claim 1 wherein the first side panel securement mechanism is a plurality of first side magnets capable of releasable contact with the first side of the appliance and the second side panel securement mechanism is a plurality of second side magnets capable of releasable contact with the second side of the appliance.

11. The article loss prevention device of claim 10 wherein the first side magnets are evenly spaced along a lower edge of the first side panel and the second side magnets are evenly spaced along a lower edge of the second side panel.

12. The article loss prevention device of claim 10 wherein the first side magnets and the second side magnets are at least two sizes.

13. A method for preventing loose articles of laundry placed on an appliance from falling behind, beside, or between and converting the appliance into a convenient and secure area for sorting and folding, the appliance having a rear side, a first side, and a second side, the method comprising:
providing a center panel having a front side, a rear side, a first end, and a second end;
providing a first side panel having a front side, a rear side, a first end, and a second end,
connecting the first end of the first side panel to the first end of the center panel;
providing a second side panel having a front side, a rear side, a first end, and a second end;
connecting the second end of the second side panel to the first end of the center panel;
facing the front sides of the center panel, the first side panel, and the second side panel toward each other;
securing the center panel to the rear side of the appliance;
securing the first side panel to first side of the appliance;
securing the second side panel to the second side of the appliance; and
inhibiting articles of laundry placed on top of the appliance from falling behind or beside the appliance or between adjacent appliances.

14. An article loss prevention device for preventing loose articles of laundry placed on an appliance from falling behind, beside, or between and converting the appliance into a convenient and secure area for sorting and folding, the appliance having a rear side, a first side, and a second side, the article loss prevention device comprising:
a center panel having a front side, a rear side, a first end, and a second end;
a first side panel having a front side, a rear side, a first end, and a second end, the first end of the first side panel being connected to the first end of the center panel;
a second side panel having a front side, a rear side, a first end, and a second end, the second end of the second side panel being connected to the first end of the center panel with the front sides of the center panel, the first side panel, and the second side panel facing each other;
a flange mounted to the rear side of the center panel;
an adjustment plate having a first end and a second end, the adjustment plate slidably positioned between the flange and the center panel;
at least one center panel magnet mounted to the second end of the adjustment plate;
at least one first side panel magnet secured to the first side panel; and
at least one second side panel magnet secured to the second side panel;
wherein the at least one center panel magnet is capable of interacting with the rear side of the appliance thereby releasably securing the center panel to the appliance;
wherein the at least one first side panel magnet is capable of interacting with the first side of the appliance thereby releasably securing the first side panel to the appliance;
wherein the at least one second side panel magnet is capable of interacting with the second side of the appliance thereby releasably securing the second side panel to the appliance; and
wherein articles of laundry placed on top of the appliance are inhibited from falling behind or beside the appliance or between adjacent appliances.

15. The article loss prevention device of claim 14 wherein the first side panel and the second side panel step down in height from the first ends of the first side panel and the second side panel adjacent the center panel and the second ends of the first side panel and the second side panel, a first height of the first side panel and the second side panel adjacent the first ends is equal to a center panel height of the center panel, a second height of the first side panel and the second side panel adjacent the second ends is less than the center panel height of the center panel.

16. The article loss prevention device of claim 14 wherein the first side panel and the second side panel are joined to the center panel by creased folds or hinged seams.

17. The article loss prevention device of claim 16 wherein the connecting or folding hinges are fabricated in an elastic material.

18. The article loss prevention device of claim 14 wherein the flange has a horizontal slot and the adjustment plate has a vertical slot overlapping the horizontal slot of the flange, and further comprising:
a securing pin extending through the horizontal slot for releasably securing the adjustment plate relative to the flange.

19. The article loss prevention device of claim 14 and further comprising:
a hook and loop fastening system interacting between the adjustment plate and the flange for releasably securing the adjustment plate relative to the flange.

20. The article loss prevention device of claim 14 and further comprising:
a plurality of first side magnets; and
a plurality of second side magnets;
wherein the first side magnets are evenly spaced along a lower edge of the first side panel and the second side magnets are evenly spaced along a lower edge of the second side panel.
